(19) United States
(12) Patent Application Publication
(10) Pub. No.: US 2022/0396483 A1
(43) Pub. Date: Dec. 15, 2022

(54) Polysulfide Compositions and Processes for Making Same

(71) Applicant: Tessenderlo Kerley, Inc., Phoenix, AZ (US)

(72) Inventors: Constance Lockhart, Phoenix, AZ (US); Michael Hojjatie, Phoenix, AZ (US); Alexandros Dimitriadis, Phoenix, AZ (US)

(73) Assignee: Tessenderlo Kerley, Inc., Phoenix, AZ (US)

(21) Appl. No.: 17/621,242

(22) PCT Filed: Jun. 22, 2020
(86) PCT No.: PCT/US2020/038977

§ 371 Date: Dec. 21, 2021

Related U.S. Application Data
(60) Provisional application No. 62/865,378, filed on Jun. 24, 2019.

(51) Int. Cl. C01B 17/34

(52) U.S. Cl. CPC C01B 17/34

(57) ABSTRACT

An aqueous polysulfide composition comprises one or more inorganic polysulfides, wherein the amount of polysulfides in the composition is at least 30% by weight, preferably at least 35% by weight, more preferably at least 40% by weight, and wherein the amount of thiosulfate anions in the composition is at most 5% by weight, relative to the total weight of the composition. In one embodiment the weight ratio of polysulfides to thiosulfates in the aqueous composition is from 55/1 to 1.5/1. In another embodiment, the aqueous polysulfide composition has a pH of at least 10. A process for preparing an aqueous polysulfide composition comprises reacting a sulfide salt (c) with elemental sulfur to form one or more polysulfide salts. The compositions have many uses and are in particular useful in metal capturing, cyanide scavenging, soil remediation, water treatment, petroleum processing, leather processing, and making of paper pulp.

### FIELD OF THE INVENTION

The present invention relates to polysulfide compositions with higher amounts of reactive compounds and to processes for making such compositions. The polysulfide compositions of the invention are useful in the treatment of water, the capturing of (heavy) metals etc.

### BACKGROUND OF THE INVENTION

Polysulfides have wide applicability in various industrial applications including the capturing of heavy metals. Alkaline polysulfides may be manufactured by, for example, reacting sodium hydroxide or calcium hydroxide with sulfur at high temperature. Calcium polysulfides for example may be prepared by boiling calcium hydroxide and sulfur together with a small amount of surfactant, or as otherwise found in the art.

Alkaline earth polysulfides and alkaline polysulfides, of which the most preferred include Calcium Polysulfide (“CaPS”), Potassium Polysulfide (“KPS”) and Sodium polysulfides (“NaPS”), find their use as depressing reagents at separation/flotation plants. The use of flotation separation in the processing of molybdenite and copper ore is well known in the industry and needs no further elaboration.

Sodium polysulfides provide significant advantages with respect to health, safety, environmental (HSE) concerns in handling, storage and application compared to sodium hydrosulfide (“NaHS”). This is primarily due to having much lower/negligible toxic Hydrogen Sulfide (H₂S) vapor pressures in comparison to the NaHS standard at the pH ranges of interest to processors. The alkaline earth polysulfides and alkaline polysulfides provide comparable separation performance to traditional alkali sulfides and are cost-effective. They proved as efficient as the gold standard NaHS in molybdenite flotation processes.

In an environment where one wants to save on water and achieve the highest possible efficiency, there is a further demand for improved water based polysulfide compositions. There is, in particular, demand for water soluble polysulfides with an increased solubility.

WO 2015/157498 and U.S. Pat. No. 2,608,298 relate to froth flotation processes wherein polysulfides are used. The polysulfides typically are produced by reacting a hydroxide with sulfur as mentioned above. This route typically generates a substantial amount of thiosulfates as by-products (see the NaPS-0 process described infra). The presence of thiosulfates is clearly of no concern in U.S. Pat. No. 2,608,298, wherein a mixture of polysulfides and thiosulfates is used as depressing agent. However, in many applications, it is desirable to minimize the thiosulfate content.

U.S. Pat. No. 5,470,486 and WO 2017/116775 relate to the making of thiosulfates and sulfates from polysulfides via an oxidation step. Again, the polysulfides are made from the reaction of hydroxide with sulfur, with the downside that a substantial amount of thiosulfates is formed as by-product (see above).

US 2003/0050511 relates to the making of a liquid polysulfide polymer by reacting a sodium polysulfide with a dihalo organic compound. The sodium polysulfide is herein produced by reacting elemental sulfur with a sodium hydrosulfide. The process also results in the formation of H₂S.

It is an aim of the present invention to provide polysulfide compositions with a lower amount of by-products and with a minimal chance of H₂S production.

### SUMMARY OF THE INVENTION

In one embodiment, the invention is directed to an aqueous polysulfide composition comprising one or more inorganic polysulfides, wherein the amount of polysulfides in the composition is at least 30% by weight, preferably at least 35% by weight, more preferably at least 40% by weight, and wherein the amount of thiosulfate anions in the composition is at most 5% by weight, relative to the total weight of the composition; and wherein the weight ratio of polysulfides to thiosulfates in the aqueous composition is from 55/1 to 1.5/1.

In another embodiment, the invention is directed to an aqueous polysulfide composition comprising one or more inorganic polysulfides, wherein the amount of polysulfides in the composition is at least 30% by weight, preferably at least 35% by weight, more preferably at least 40% by weight, and wherein the amount of thiosulfate anions in the composition is at most 5% by weight, relative to the total weight of the composition; and wherein the aqueous polysulfide composition has a pH of at least 10.

In a further embodiment, the invention is directed to a process for preparing an aqueous polysulfide composition comprising at least 30% by weight, preferably at least 35% by weight, of one or more polysulfide salts and at most 5% by weight of thiosulfate anions, relative to the total weight of the composition, said process comprising reacting a sulfide salt (c) with elemental sulfur to form the one or more polysulfide salts (d).

These polysulfide compositions and processes of the invention are advantageous in providing higher amounts of reactive compounds and reduced impurities. Additional embodiments and advantages of the invention will be apparent from the detailed description.

### BRIEF DESCRIPTION OF THE DRAWING

FIG. 1 shows the wt % of sodium thiosulfate in sodium polysulfide produced from NaSH and sulfur according to one embodiment of the invention and in a conventional sodium polysulfide prepared from NaOH and sulfur, after synthesis and subsequent treatment for 1-5 hours at 200° C., as described in the Example.

### DESCRIPTION OF THE INVENTION

Against this background, the invention provides an aqueous polysulfide composition comprising one or more inorganic polysulfides, wherein the composition comprises at least about 30% by weight, more specifically at least about 35% by weight of said polysulfides. In specific embodiments, the polysulfides typically comprise ammonium polysulfides (a1) and/or alkali metal polysulfides (a2) and/or alkaline earth polysulfides (a3) and at most about 15% by weight of thiosulfate anions. Unless specified otherwise, weight percentages are relative to the total weight of the aqueous polysulfide composition.

The term “inorganic polysulfides” refers to compounds that dissolve in water to form HSₓ⁻ or Sₓ⁻² anions where x is equal to or greater than 2 but usually no more than 8, preferably no more than 6. Examples include sulfanes (H₂Sₓ) and polysulfide salts or mixtures thereof. More specific embodiments of the invention are ammonium polysulfides (a1) and/or alkali metal polysulfides (a2) and/or alkaline earth polysulfides (a3). Examples of alkali metal polysulfides are for instance sodium polysulfides and/or potassium polysulfides. Examples of alkaline earth polysulfides are for instance calcium polysulfides and/or magnesium polysulfides. When dissolved in water the inorganic polysulfides have a pH value greater than 7, for example greater than 9 or greater than 10.

In an embodiment of the invention, the amount of polysulfides, more in particular of polysulfide salts, in the aqueous composition is at least about 31, 32, 33, 34, 35, 36, 37, 38, 39 or 40% by weight. In additional embodiments, this amount is at least about 41, 42, 43, or 44% by weight. In additional embodiments, this amount is at least about 45, 46, 47% by weight, even at least about 48, 49 or 50% by weight or more.

The amount of thiosulfate anions present in the aqueous compositions of the invention typically is at most about 14, 13, 11, 10, more specifically, at most about 9, 8, 7, 6% by weight. More specifically, the amount of thiosulfate anions present in the aqueous compositions of the invention is at most about 5, 4 or 3% by weight. Even more specifically, this amount is at most about 2.9, 2.8, 2.7, 2.6, 2.5, 2.4, 2.3, 2.1, or 2% by weight. This amount may even be at most about 1, 0.9, 0.8, 0.7, 0.6 or 0.5% by weight.

Typically, the polysulfides are inorganic polysulfides, more in particular inorganic water soluble polysulfides. Preferred polysulfides are polysulfide salts. Typically one or more alkaline polysulfides and/or one more alkaline earth polysulfides are present. Also preferred are ammonium polysulfides.

Alkaline polysulfides typically correspond to the formula M-Sq-M, wherein the “M” is independently selected from alkali metal ions such as sodium and/or potassium ions, preferably sodium ions, wherein the “S” has its normal meaning, that is, a sulfide, and wherein “q” is equal to or greater than 2. Preferably, “q” is an integer from 2 to 5, more preferably from 2 to 4. Most preferably, the alkaline polysulfide has an “average q” of between 3.5 and 5, of between 3.5 and 4.5.

Alkaline earth polysulfides typically correspond to the formula M-Sq, wherein the “M” is independently selected from alkaline earth ions such as calcium or magnesium, wherein the “S” has its normal meaning, that is, a sulfide and wherein “q” is equal to or greater than 2.

Preferably, “q” is an integer from 2 to 6, more preferably from 3 to 6. Most preferably, the alkaline earth polysulfide has an “average q” of between 3 and 5, or between 4 and 5.

It is possible that the aqueous polysulfide composition of the invention comprises mixtures of 2 or more different polysulfide salts. These can be mixtures of different alkaline polysulfides, of different alkaline earth polysulfides, or of alkaline and alkaline earth polysulfides etc.

Preferred polysulfides are calcium polysulfides, magnesium polysulfides, sodium polysulfides, potassium polysulfides, ammonium polysulfides, and mixtures thereof (of any of these). In more specific embodiments, the polysulfides are calcium polysulfides, sodium polysulfides, potassium polysulfides, ammonium polysulfides, or mixtures thereof (of any of these).

Preferred in the context of the invention are calcium polysulfides and/or sodium polysulfides and/or potassium polysulfides. Most preferred are sodium polysulfides and/or potassium polysulfides.

In an embodiment of the invention, the aqueous polysulfide composition of the invention comprises one or more sodium polysulfides. In another embodiment of the invention, the aqueous polysulfide composition comprises one or more potassium polysulfides. In yet another embodiment of the invention, the aqueous polysulfide composition comprises one or more calcium polysulfides.

Preferably, the aqueous polysulfide compositions of the invention (any of the above) are aqueous solutions. Preferred are saturated solutions in water. An embodiment of the invention relates to an aqueous solution of alkali metal polysulfides. Another embodiment of the invention relates to an aqueous solution of alkaline earth polysulfides. Yet another embodiment of the invention relates to an aqueous solution of alkali metal polysulfides and alkaline earth polysulfides.

An embodiment of the invention relates to an aqueous solution of sodium polysulfides. Another embodiment of the invention relates to an aqueous solution of potassium polysulfides. Yet another embodiment of the invention relates to an aqueous solution of calcium polysulfides.

In specific embodiments, the aqueous polysulfide composition of the invention (any of the above) has a total S content (expressed in wt %) of at least about 26, 27, 28 or 29%. Preferably, this content is at least about 30, 31, 32 or 33%.

In specific embodiments, the aqueous polysulfide composition of the invention (any of the above) has a total S⁻² content (expressed in wt %) of at least about 6, 6.5, or 7%. Preferably, this content is at least about 7.1, 7.2, 7.3 or 7.4%. More preferably, this content is at least about 7.5, 7.6, 7.7, 7.8, 7.9 or 8%. It can even be at least about 8.1, 8.2, 8.3, 8.4, 8.5, 8.6, 8.7, 8.8, 8.9 or 9%.

In specific embodiments, the aqueous polysulfide composition of the invention (any of the above) has a S⁰ content of at least about 15, 16, 17 or 18% by weight. Typically, this content is at most about 18.5, 19, 19.5, 20, 20.5, 21% by weight. By “S⁰” is meant the internal sulfur of the polysulfide, the part of the polysulfide backbone that is not reactive. Included herein are also minor amounts of sulfate and sulfite.

In specific embodiments, the % S (determined analytically by AOAC method 980.2) in the inorganic polysulfide, more in particular the polysulfide salt (such as a Na₂Sₓ) is at least about 24, 24.5, 25, 25.5, 26, 26.5 or 27% by weight. More preferably, the % S in the inorganic polysulfide, more in particular the polysulfide salt (such as a Na₂Sₓ) is at least about 27.5, 28, 28.5, 29, 29.5 or 30% by weight.

In specific embodiments, the sum of % S+% of alkaline and/or alkaline earth metal, for example the % Na (as calculated from % Na and % S), in the aqueous composition of the invention, is at least about 35, 35.5, 36, 36.5, 37, 37.5, 38, 38.5, 39, 39.5 or 40% by weight. In more specific embodiments, the sum of % S+% of alkaline and/or alkaline earth metal is at least about 41, 42, 43, 44 or 45% by weight, or, more specifically, at least about 46, 47, 48, 49 or 50% by weight.

In specific embodiments, the ratio of polysulfides over thiosulfates in the aqueous composition is from about 55/1 to about 1.5/1, more in particular from about 50/1 to about 1.8/1. Preferably, this ratio is at least 2, at least 2.5, preferably at least 2.6, 2.7, 2.8, 2.9 or 3 over 1. Often, this ratio is at least 3, 3.5, 4, 4.5, 5, 5.5, 6, 6.5, 7, 7.5, 8, 8.5, 9, 9.5 or 10 over 1.

In specific embodiments, the aqueous polysulfide composition of the invention (any of the above) has a pH in the range of from about 8 to about 13, typically from about 8.5 to about 13. Preferably, the pH is at least about 9, 9.5 or even 10.

In an embodiment of the invention, the aqueous polysulfide composition is a saturated solution of polysulfide salts in water.

In one embodiment, the aqueous polysulfide composition comprises one or more inorganic polysulfides, wherein the amount of polysulfides in the composition is at least 30% by weight, preferably at least 35% by weight, more preferably at least 40% by weight, and wherein the amount of thiosulfate anions in the composition is at most 5% by weight, relative to the total weight of the composition; and wherein the ratio of polysulfides over thiosulfates in the aqueous composition is from 55/1 to 1.5/1.

In another embodiment, the aqueous polysulfide composition comprises one or more inorganic polysulfides, wherein the amount of polysulfides in the composition is at least 30% by weight, preferably at least 35% by weight, more preferably at least 40% by weight, and wherein the amount of thiosulfate anions in the composition is at most 5% by weight, relative to the total weight of the composition; and wherein the aqueous polysulfide composition has a pH of at least 10.

Aqueous polysulfide compositions of the invention can be prepared in different ways. Below some preferred manufacture processes are discussed. In a conventional process (NaPS-0), a sodium polysulfide is prepared as follows: 6NaOH+10 S→2Na₂S₄+Na₂S₂O₃+3H₂O. For a calcium polysulfide, similar conventional processes are as follows: 3Ca(OH)₂+10S→2 CaS₄+CaS₂O₃+3H₂O or: 2Ca(OH)₂+6S→CaS₄+CaS₂O₃+3H₂O. However, the present inventors have found that it is preferred to avoid the presence of excess soluble hydroxide, which is encountered in such conventional methods or to assure that the soluble hydroxide is consumed prior to the addition of elemental sulfur to form the polysulfide(s). Advantageously, high amounts of polysulfide are produced and the production of thiosulfate anions is reduced.

Provided herein is also a process for preparing a polysulfide composition having at least about 35% by weight of polysulfides, more in particular of polysulfide salts, said composition comprising at most about 15% by weight, typically at most about 10% by weight, preferably at most about 5% by weight, more preferably at most about 3% by weight of thiosulfate anions, relative to the total weight of the composition. The process comprises a step (i) of reacting a hydrosulfide (b) and/or a sulfide (c) with elemental sulfur.

In one embodiment of the invention, step (i) of the process comprises reacting an ammonium hydrosulfide (b1) and/or an alkali metal hydrosulfide (b2) and/or an alkaline earth hydrosulfide (b3) with elemental sulfur.

In another embodiment of the invention, step (i) of the process comprises reacting an ammonium sulfide (c1) and/or an alkali metal sulfide (c2) and/or an alkaline earth sulfide (c3) with elemental sulfur. In a preferred embodiment, this step (i) is preceded by a step of reacting a hydroxide, more in particular a soluble hydroxide, with a hydrosulfide (b) to form a sulfide (c).

In a preferred embodiment, the polysulfide salt(s) is prepared in two steps, said steps comprising:
First, reacting a hydroxide (a), more in particular a soluble hydroxide (a), with a hydrosulfide (b) to form a sulfide (c), and
Second, converting said sulfide (c) into a polysulfide (d) via further reaction with elemental sulfur.

Generally, the polysulfide, more in particular the polysulfide salt, is prepared in the absence of oxygen, preferably under a nitrogen blanket. Typically, the aqueous polysulfide composition that is prepared has a pH in the range of from about 8 to about 13, typically from about 8.5 to about 13. In specific embodiments, the pH is at least about 9, at least about 9.5 or at least about 10.

Reaction temperatures are in general between about 50° C. and about 120° C., more preferably between about 50° C. and about 115° C. Often the temperature is at least about 55° C., more preferably at least about 60° C. In general, the reaction temperature is at most about 100° C., preferably at most about 95° C., more preferably at most about 90° C. Reaction times can vary but in general vary in the range of from about 20 minutes to about 150 minutes. In general, the reaction time is between about 25 minutes and about 120 minutes. Stirring speed is adapted to the circumstances to achieve a good mixing and to reduce gas bubbles.

In a first embodiment of the invention, in step (ss) as described, one more hydrosulfide salts (b) are reacted with elemental sulfur. In specific embodiments, this step is followed by a step (adj) comprising adjusting the pH where needed so that the pH of the aqueous polysulfide composition is in the range of from about 8 to about 13, preferably from about 8.5 to about 13, more preferably from about 9 to about 13. Most preferably, the pH is adjusted to be at least about 10 or higher, for example to a pH of from about 10 to about 13, to maintain the H₂S byproduct which is formed in solution, thereby avoiding noxious H₂S gas. The hydrosulfide salt is preferably selected from sodium hydrosulfide, potassium hydrosulfide, ammonium hydrosulfide, calcium hydrosulfide, magnesium hydrosulfide, or any mixture thereof (of any of these).

In a second embodiment of the invention, one or more sulfide salts (c) are reacted with elemental sulfur to form polysulfides of the invention. In a specific embodiment, this step is preceded by a step (hss) of reacting a hydroxide (a) with one or more hydrosulfide salts (b) to form the sulfide salt (c) that is then reacted in step (ss) with elemental sulfur to form a polysulfide salt (d). Most preferably the hydroxide salt and the hydrosulfide salt share a common cation. Preferably step (sss) is in the absence of a hydroxide, to avoid thiosulfate anion formation. Preferably at most 5, 4, 3, 2, 1 wt % or less of hydroxides is present in step (sss).

The hydroxide (caustic), most often, is provided in the form of an alkaline solution having a strength of at least about 20 wt %, preferably at least about 25 wt %, more preferably at least about 30 wt %. Preferably, the alkaline solution has a strength of from about 30 wt % to about 50 wt %, in particular with alkali hydroxides being used.

In a preferred embodiment, the hydrosulfide (b) is selected from ammonium hydrosulfides (b1) and/or from alkali metal hydrosulfides (b2) and/or from alkaline earth hydrosulfides (b3). Typically, the one or more hydrosulfide salts are selected from ammonium hydrosulfides, sodium hydrosulfides, potassium hydrosulfides, calcium hydrosulfides and/or magnesium hydrosulfides. More typically, the one or more hydrosulfide salts are selected from ammonium hydrosulfides, sodium hydrosulfides, potassium hydrosulfides and/or calcium hydrosulfides. Preferred are sodium hydrosulfides and/or potassium hydrosulfides and/or calcium hydrosulfides. More preferred are sodium hydrosulfides and/or potassium hydrosulfides. Particularly preferred are sodium hydrosulfides.

The sulfide (c) that is (further) reacted with elemental sulfur most typically is an ammonium sulfide (c1) and/or an alkali metal sulfide (c2) and/or an alkaline earth sulfide (c3). In a preferred embodiment, one or more alkali metal sulfides (c2) and/or one or more alkaline earth sulfides (c3) are reacted with elemental sulfur to form a corresponding polysulfide salt. Preferred alkali metal sulfides are potassium sulfide and/or sodium sulfide. The term “sulfide” as used herein is not to be confused with the term “polysulfide” and certainly not with the term “polymeric polysulfide” formed from organic reactants as disclosed in US 2003/0050511.

The elemental sulfur (S) used in the above described reactions may be either solid or liquid/molten sulfur, but preferably it is molten sulfur so that the stirring action in the reactor breaks up the molten sulfur feed as it cools to form small solid sulfur particles. Alternatively, small solid sulfur particles can be added directly to the reaction vessel. Small sulfur particles advantageously have a large total surface area available for reaction. When sulfur is used in the molten/liquid state, a higher reactor pressure and higher stirring agitation may be required to keep molten sulfur dispersed into small droplets.

In an embodiment of the invention, the aqueous polysulfide composition obtained (any of the above) may be subjected to a heat treatment to lower the amount of thiosulfates initially present. In such step, the aqueous polysulfide composition is kept at a temperature of about 50° C. to about 70° C. for a period of about 30 to about 60 minutes. This step is optional and often not needed.

According to an embodiment of the invention, the aqueous polysulfide composition prepared with a method of the invention (any of the above) comprises one or more polysulfide salts of the formula X-Sq-X, wherein the X is independently selected from alkali metal ions such as sodium and/or potassium ions, preferably sodium ions, wherein the “5” has its normal meaning, that is, a sulfide, and wherein “q” is (an integer of) equal to or greater than 2, preferably “q” is an integer from 2 to 5, with a preferred “average q” of between 3.5 and 5, of between 3.5 and 4.5.

According to an embodiment of the invention, the aqueous polysulfide composition prepared with a method of the invention (any of the above) comprises one or more polysulfide salts of the formula Y-Sq, wherein the Y is independently selected from alkaline earth ions, wherein the “5” has its normal meaning, that is, a sulfide, and wherein “q” is (an integer of) equal to or greater than 2, preferably “q” is an integer from 2 to 6, more preferably “q” is from 3 to 6, with a preferred “average q” being between 3 and 5, or between 4 and 5.

Polysulfides (d) of the invention typically have a (calculated) molecular weight of from about 110 to about 350. In a more specific embodiment, the polysulfides (d) have a molecular weight of from about 110 to about 270, or more specifically, from about 110 to about 240.

According to an embodiment of the invention, the aqueous polysulfide composition prepared with a method of the invention (any of the above) comprises one or more polysulfide salts selected from calcium polysulfides, magnesium polysulfides, sodium polysulfides, potassium polysulfides, ammonium polysulfides, and mixtures thereof (of any of these). Preferred are calcium polysulfides, sodium polysulfides, potassium polysulfides, ammonium polysulfides, and mixtures thereof (of any of these). Preferred in the context of the invention are calcium polysulfides, sodium polysulfides, potassium polysulfides, and mixtures thereof (of any of these). Most preferred are sodium polysulfides and/or potassium polysulfides. Particularly preferred are sodium polysulfides.

In a preferred embodiment of the invention, an aqueous solution is prepared that comprises one or more polysulfide salts in water. In an embodiment of the invention, the aqueous polysulfide composition that is prepared comprises one or more sodium polysulfides. In another embodiment of the invention, the aqueous polysulfide composition that is prepared comprises one or more potassium polysulfides. In yet another embodiment of the invention, the aqueous polysulfide composition that is prepared comprises one or more calcium polysulfides.

Preferably, the aqueous polysulfide compositions that are prepared (any of the above) are aqueous solutions. Preferred are saturated solutions in water. An embodiment of the invention relates to an aqueous solution of alkali metal polysulfides. Another embodiment of the invention relates to an aqueous solution of alkaline earth polysulfides. Yet another embodiment of the invention relates to an aqueous solution of alkali metal polysulfides and alkaline earth polysulfides.

In an embodiment of the invention, an aqueous solution of sodium polysulfides is prepared. In another embodiment of the invention relates an aqueous solution of potassium polysulfides is prepared. In yet another embodiment of the invention an aqueous solution of calcium polysulfides is prepared.

Typically, the polysulfide composition prepared is an aqueous composition comprising at least about 30 wt % (percent by weight), more specifically at least about 40 wt % of water, and more specifically, at least about 45 wt % of water.

The above (any of the aqueous polysulfide compositions described above) can be transformed into a solid polysulfide based product, typically a hydrated salt, using any conventional technique, including, but not limited to, removal of water by evaporation, distillation, freeze drying, or the like. In said case, the process of the invention will further comprise a step of converting the aqueous polysulfide composition into a solid product. For Na₂S₃ and Na₂S₂—or ratios of S:Na of 3:2 or 1:1—the solubility of these polysulfides is lost when cooled to room temperature. This is particularly true when we up the concentration to 50% or more. A simple way of doing that is by preparing a solution that contains at least about 45 wt %, at least about 50 wt %, at least about 51 wt % and more of the polysulfides (polysulfide salts). In the case of Na₂S₃, a hydrated solid can be obtained from a solution having at least about 50 wt % of Na₂S₃. A preferred route consists of reacting first NaOH+NaSH to form Na₂S and water, and then reacting Na₂S with sulfur in an amount to form Na₂S₃ by a further reaction at about 75° C. Upon cooling, a hydrated solid will then result. Alternatively, Na₂S is turned into Na₂S₃ with a mole ratio S:Na of 2.5:2 to 3.5:2, preferably 3:2, by a further reaction with S at about 75° C. The hydrated solid can be removed by filtration and be further dried if desired, for instance by drying it in an oven at a temperature of about 60° C. The same can be done starting from a solution having at least about 46 wt % of Na₂S₂. To make a hydrated salt of Na₂S₄, the Na₂S₄ concentration needs to be well beyond 50 wt % since Na₂S₄ is soluble at room temperature and normal pressure at a concentration of about 50 wt %. This can be done by increasing the concentration to a level where Na₂S₄ is insoluble, i.e, by reducing the hydration of the solution.

The aqueous polysulfide compositions of the invention have many end uses and can for instance be employed for the capturing of metals and/or for the scavenging of cyanide. For the capturing of metals, any of the above described aqueous polysulfide compositions can be used, though those based on sodium polysulfides and/or potassium polysulfides and/or calcium polysulfides are preferred. The aqueous polysulfide compositions of the invention proved in particular suitable for the capturing of metals like Ni, Ca, Cd, Cu, Mo, Pb, Hg, Cr⁺⁶, Ag, Ti, Fe and/or Zn

The capturing of metals herein can be through precipitation, chelation, solubilization, complexation, by the use of ligands, complexing agents, by forming insoluble and precipitating sulfide, etc. The polysulfides present in the aqueous composition of the invention can herein act as lixiviant, depressants, etc.

The aqueous polysulfide compositions of the invention are in particular useful for the capturing of copper (Cu) and the separation of copper from molybdenum (Mo) as described in WO 2015/157498. The aqueous polysulfide composition of the invention herein acts as a depressant in separating copper from molybdenum. The act of the depressant is to render the Cu minerals hydrophilic, so that they remain in the aqueous phase, i.e., they are “depressed”, so that they do not come into the froth phase. Meanwhile, Mo naturally floats into the froth phase due to its hydrophobicity. The aqueous polysulfide compositions of the invention outperformed the polysulfide compositions described in WO2015/157498. Both calcium polysulfide solutions and sodium polysulfide solutions according to the invention can be used for these purposes.

The polysulfide, more in particular the polysulfide salts present in the aqueous compositions of the invention, can complex with both base metals and heavy metals. Consequently, the materials according to the invention will further also be suitable for heavy metal removal in soil remediation and water treatment. Materials of the invention can also be used to provide sulfur species in a Kraft pulping process.

The aqueous polysulfide compositions of the invention can also be used for the scavenging of (free) cyanide in e.g. refinery waste water effluents. This can lead to a better corrosion control. Free cyanide is herein scavenged before it gets to the sour water stripper. Polysulfides present in the aqueous composition of the invention will scavenge the free cyanide and convert it into a thiocyanate, which is easy to handle in refinery water treatment facilities. For the scavenging of (free) cyanide, particularly solutions based on ammonium polysulfides are proven useful.

The aqueous polysulfide compositions of the invention can also be used in making of paper pulp; in making leather, for instance in the dehairing of hides before tanning; in wool pulling, in the taking of e.g. wool from sheepskins; in mineral ore beneficiation, e.g. as a reagent in flotation cells to react with heavy metals such a copper (Cu), lead (Pb) or molybdenum (Mo); in petroleum processing; in the treatment of gases; and in the treatment of waste water streams.

An aspect for the invention hence also relates to the use of a polysulfide composition of the invention (any of those described), for the capturing of metals, for the treatment of water. The polysulfide composition of the invention can also be used in mining applications, for instance as flocculation agent, as lixiviant and/or as complexing ligand. Metals that can be captured are Ni, Ca, Cd, Cu, Mo, Pb, Hg, Cr⁺⁶, Ag, Ti, Fe and/or Zn.

Throughout the whole of the invention including the Examples section, the following methods haven been used.

Total Sulfur content (in wt %, weight percentages): was determined per AOAC Official Method 980.02.

Thiosulfate content (in wt %, weight percentages): was determined via ion chromatography (IC). Below is information on the equipment, the column, mobile phase and flow rates as used. Via IC the amount of S₂O₃⁻² anions is measured, which amounts in the invention are calculated back to weight percentages. Instrument: Thermo Dionex ICS-5000+DP; Column: IonPac AS11 RFIC, 4×250 mm; Guard Column: IonPac AG11 RFIC, 4×50 mm; Mobile Phase: 10 mM KOH; Flow Rate: 1.0 ml/min; Column Temperature: 30° C.

Sulfide content (in wt %, weight percentages): was determined via Back Titration with Sodium Thiosulfate after reaction with standard Iodine titration reagent. The amount of Sulfide is calculated by deducting the equivalents of iodine consumed by the thiosulfate present—as determined by IC—from the total equivalents of iodine consumed.

Total Sodium (in wt %, weight percentages): was determined using Atomic Absorption Spectroscopy (AAS). Instrument used: Shimadzu AA-6800; [symbol] =330 nm; Matrix/Ionization Suppressant: 2000 ppm KCl. For total Potassium, [symbol] =404.4 nm; Matrix/Ionization Suppressant: 3000 ppm CsCl₃.

Total Calcium (in wt %, weight percentages): was determined using EDTA titration.

In all of the above measurements were done at room temperature (near 20° C.) and at atmospheric pressure, this normally right after production. If any heat treatment is performed post-reaction before measuring the different amounts, then this is explicitly mentioned.

The invention is now described in detail below, via the following Examples, which are not intended to be limitative.

### EXAMPLES

### Example 1—Sodium Polysulfide Synthesis According to the Invention

Two new products were synthesized for evaluation per the reaction paths noted. The objective is to attain a high S⁻², low S₂O₃⁻² Sodium Polysulfide (NaPS).

### Making of the First Product According to the Following Route:

2NaSH+3S→Na₂S₄+H₂S (1)

651 gm of 44.5% (wt %) NaSH was reacted with 254 gm of sulfur (small solid particles) and 189 gm of addition water, thereby obtaining a 46% (wt %) sodium polysulfide (NaPS) solution (called NaPS-1). Reaction was conducted at 75° C. for 2 hours. A small amount of sulfur remained unreacted. Adjusting the pH to from about 8.5 to at least 10 avoided H₂S gas evolution and, instead, maintained the H₂S by product in solution.

### Making of the First Product According to the Following Route:

1^{st} reaction: NaOH+NaSH→Na₂S+H₂O

2^{nd} reaction: Na₂S+3S→Na₂S₄ (2)

Here, 207 gm of a commercial 50% (wt %) NaOH solution was reacted with 324 gm of the same 44.5% (wt %) NaSH product and 220 gm of additional water. The 1^{st} reaction was conducted for 30 minutes at 75° C. For the 2^{nd} reaction, 254 gm of sulfur (small solid particles) was added and reaction was continued for an additional 90 minutes at 75° C. This lead to a 46% (wt %) NaPS solution (called NaPS-2)

A description and characterization of both products is presented in Table 1 below.

In commercial 38% Sodium Polysulfide solutions (NaPS-0) available on the market, prepared from caustic and elemental sulfur, the amount of polysulfides present is about 21 wt % and the amount of sodium thiosulfates in this product is about 14-17 wt % (total conc. being about 35-38 wt %). Materials of the invention have thus a higher amount of active ingredient and less of undesired by-products. The ratio of sodium polysulfide:sodium thiosulfate in the conventional NaPS-0 is approximately 1.3:1 which is an amazing difference compared to products NaPS-1 and NaPS-2 according to the invention which contain very little thiosulfate anion.

It was noted that when NaPS-0 was subjected to a heat treatment (2 hours at near 200° C. in a reactor), this did not reduce the amount of sodium thiosulfates as expected. S₂O₃⁻² does not decompose at the elevated temperature of 200° C., but rather increases.

### Example 2—Reducing the H₂S Vapor Formed while Making NaPS-1

A disadvantage of product NaPS-1 (see above) is the build-up of a H₂S pressure. NaPS-1—when adjusted post-reaction to the same pH as NaPS-0—had the same low S₂O₃⁻² content as NaPS-1 itself having a pH near 10. NaPS-1 pH adjusted contains over 50 wt % of Na₂Sx and less than 1 wt % of S₂O₃⁻² anions, whereas NaPS-0 (for example, Tetragard™, available from Tessenderlo Kerley Inc) has near 21 wt % of Na₂Sₓ and well over 10 wt % of S₂O₃⁻² anions (as measured via IC). NaPS-1 and the NaPS-1 that is pH adjusted are similar in composition and behavior. S₂O₃⁻² content remains diminished in the pH adjusted solution.

TABLE 1

| Product | NaPS-1 | NaPS-2 |
|---|---|---|
| Raw Material | | |
| NaOH (50%) gm | 0 | 206.6 |
| NaSH (44.5%) gm | 650.8 | 325.4 |
| S (gm) | 188.8 | 253.5 |
| H₂O (gm) | 253.7 | 219.5 |
| total (gm) | 1093.3 | 1005.0 |
| Filtrate (gm) | 984.0 | 968.7 |
| Solids (gm) | 7.3 | 4.3 |
| Total Recovery (gm) | 991.3 | 973.0 |
| % Recovery | 90.7 | 96.8 |
| % Filtrate | 99.3 | 99.6 |
| % Solid | 0.7 | 0.4 |
| Assay | | |
| pH | 9.4 | 12.2 |
| % Na | 11.5 | 11.6 |
| % S (total) | 34.7 | 34.4 |
| % NaPS | 46.2 | 45.9 |
| NaSₓ average x number | 4.3 | 4.3 |
| S:Na | 2.2 | 2.1 |
| wt % S⁼ | 9.2 | 7.9 |
| wt % Na₂S₂O₃ | 2.3 | 2.1 |
| wt % S (Na₂S₂O₃) | 0.9 | 0.9 |
| wt % S° | 24.6 | 25.4 |

The objective of the pH adjustment was to reduce the H₂S in the vapor space of the product, in particular as it is a safety concern. This proved possible without disadvantage for the pH adjusted product. Additional properties of the product prepared from NaSH (NaPS-1), both pH adjusted and pH unadjusted, and the conventional Tetragard™ product are presented in Table 2. The product prepared from NaSH—NaPS-1—is 34% more concentrated than Tetragard™. The S₂O₃⁻² content is less than 1 wt %, compared to >10 wt % in Tetragard™. The active ingredient S⁻² is 66% higher in the NaSH-based product NaPS-1.

TABLE 2
A comparison of Tetragard ™, NaPS-1,
and NaPS-1 that is pH adjusted

| NaPS | Tetragard ™ | NaPS-1 | NaPS-1—pH adjusted |
|---|---|---|---|
| pH | 12.5 | 9.9 | 12.1 |
| ρ (gm/ml @ 23.3° C.) | 1.362 | 1.437 | 1.445 |
| wt % Na⁺ | 12.1 | 13.6 | 14.2 |
| wt % S, total | 26.2 | | 37.3 |
| wt % Na₂Sₓ | 38.3 | | 51.5 |
| wt % S₂O₃⁻² | 10.5 | 0.8 | 0.9 |
| wt % S⁻² | 5.9 | 10.2 | 9.9 |
| wt % S^{o} | 13.6 | | 26.2 |

### Example 3—Sodium Polysulfides Prepared from NaSH Stand High Temperatures

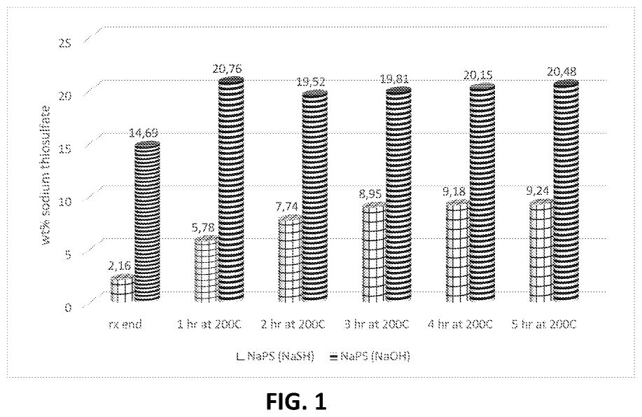

The NaPS-1 and NaPS-0 were subjected to a heat treatment post-reaction at 200° C., in a reactor for about 1-5 hours. As shown in FIG. 1, the amount of sodium thiosulfates in NaPS-1 (prepared from NaSH) remains below 10 wt %. This in contrast to the similar NaPS product prepared from NaOH, NaPS-0, such as Tetragard™.

### Example 4—Potassium Polysulfide Synthesis According to the Invention

Similarly, a potassium polysulfide (KPS-2) was prepared from KSH (potassium hydrosulfide). KSH was first prepared from KOH (potassium hydroxide) and H₂S by the reaction:

KOH+H₂S→KSH+H₂O (3)

In one example, 212.5 gm of H₂S was purged into 699.7 gm of a 50% (wt %) solution diluted with an additional 87.8 gm of water. stirring was done at ^{˜}400 rpm. purging was conducted at such a rate where back-pressure was avoided. The maximum temperature reached per the rate of purging was 80° C. The product was found to contain 45.21% (wt %) KSH in water by iodine titration. wt % K by AAS=23.56. wt % S₂O₃⁻² by IC=0.03. The product made was barely colored.

Using the above KSH solution a KPS-2 potassium polysulfide solution was prepared as follows

1st reaction: KOH+KSH→K₂S+H₂O

2nd reaction: K₂S+3S+H₂O→K₂S₄+H₂O (4)

In the 1^{st} reaction, 122 gm of 50 wt % KOH was reacted with 45 wt % KSH at 75° C. for 30 minutes with stirring at 500 rpm. The pale yellow solution of K₂S (1^{st} reaction product) was further reacted with elemental sulfur—240 gm of 1^{st} reaction product KSH (45 wt %) was mixed at 500 rpm and reacted with 210 gm of fine sulfur solid at 75° C. for 90 minutes). The polysulfide product of the 2^{nd} reaction retains the typical dark red appearance of polysulfide solutions. Assay of the low thiosulfate potassium polysulfide=28.7 wt % S, 0.5 wt % S₂O₃⁻² by IC, 16.8 wt % K by AAS. Total K+total S=28.7+16.8=44.5 wt %.

Polysulfides according to the invention proved excellent reagents in a Cu/Mo separation flotation processes in comparison to the NaHS standard. Polysulfides according to the invention outperformed Tetragard™ and the calcium polysulfides as used in WO 2015/175498.

1. An aqueous polysulfide composition comprising one or more inorganic polysulfides, wherein the amount of polysulfides in the composition is at least 30% by weight, and wherein the amount of thiosulfate anions in the composition is at most 5% by weight, relative to the total weight of the composition; and wherein the weight ratio of polysulfides to thiosulfates in the aqueous composition is from 55/1 to 1.5/1.

2. (canceled)

3. The aqueous polysulfide composition according to claim 1 wherein the one or more polysulfides comprise one or more polysulfide salts selected from (a1) ammonium polysulfides and/or (a2) alkali metal polysulfides and/or (a3) alkaline earth polysulfides.

4. The aqueous polysulfide composition according to claim 1, wherein the one or more polysulfide salts are selected from calcium polysulfides, sodium polysulfides, potassium polysulfides, ammonium polysulfides, and any mixture of two or more thereof.

5. The aqueous polysulfide composition according to claim 1, having a pH of from 10 to 13.

6. A solid polysulfide based product that is prepared from the aqueous polysulfide composition of claim 1.

7. A process for preparing an aqueous polysulfide composition comprising at least 30% by weight, of one or more polysulfide salts and at most 5% by weight of thiosulfate anions, relative to the total weight of the composition, said process comprising reacting a sulfide salt (c) with elemental sulfur to form the one or more polysulfide salts (d).

8. The process of claim 7, comprising first reacting a hydroxide (a) with a hydrosulfide salt (b) to form the sulfide salt (c) and then reacting the sulfide salt (c) with elemental sulfur to form the one or more polysulfide salts (d).

9. The process according to claim 7, wherein the hydrosulfide salt (b) comprises ammonium hydrosulfide (b1) and/or an alkali metal hydrosulfide (b2) and/or an alkaline earth hydrosulfide (b3).

10. The process according to claim 7, wherein the hydroxide (a) comprises alkali metal hydroxide and the hydrosulfide salt (b) comprises alkali metal hydrosulfide (b2).

11. The process according to claim 7, wherein the reaction of the sulfide salt (c) with elemental sulfur to form the one or more polysulfide salts (d) is conducted in the absence of oxygen, and preferably also in the absence of a hydroxide.

12. The process according to claim 7, wherein the polysulfide composition comprises at least 40% by weight, of the one or more polysulfide salts, relative to the total weight of the composition.

13. The process according to claim 7, wherein the amount of thiosulfate anions in the polysulfide composition is at most 3% by weight, relative to the total weight of the composition.

14. The process according to claim 7, wherein the ratio of polysulfides to thiosulfates in the composition is from 55/1 to 1.5/1.

15. The process according to claim 7, further comprising a step of converting the aqueous composition into a solid polysulfide product, or into a hydrated polysulfide salt.

16.-17. (canceled)
